(19) United States
(12) Patent Application Publication
(10) Pub. No.: US 2006/0236995 A1
(43) Pub. Date: Oct. 26, 2006

(54) Solid fuel igniter

(76) Inventor: Chiou-Fu Chang, Hsinchu Hsien (TW)

Correspondence Address: Chiou-Fu CHANG, P.O. Box No. 6-57, Junghe, Taipei, 235, TW

(21) Appl. No.: 11/111,903

(22) Filed: Apr. 22, 2005

(51) Int. Cl. A47J 37/07; A47J 37/00

(52) U.S. Cl. 126/25 R; 126/25 B

(57) ABSTRACT

A solid fuel igniter that provides for initial heating of solid fuel pieces to expedite reaching a self-ignition preparatory state. The igniter comprises a primary fire generating chamber, wherein heat energy is generated and transmitted upwards to an enclosing body having a top opening of wide cross section that tapers downwards to a lower end of narrower cross section. The enclosing body holds the solid fuel pieces packed therein, and a primary fire in the generating chamber heats a smaller number of the solid fuel pieces packed on the bottom of the enclosing body, which generate spontaneous and intense heat energy that propagates thermal waves uniformly upward, thereby enabling all of the solid fuel pieces to uniformly reach the self-ignition preparatory state.

### BACKGROUND OF THE INVENTION

(a) Field of the Invention

The present invention relates to a solid fuel igniter, and more particularly to an igniter that provides for uniform packing of solid fuel pieces, thereby enabling the fuel pieces to reach a self-ignition preparatory state.

An additional fire source, using tinder, and so on, is necessary in the initial stage of heating the solid fuel to directly enkindle the solid fuel pieces packed in a bottom portion of the igniter.

(b) Description of the Prior Art

In recent times, it has become popular for restaurants to provide a dining method using a tabletop charcoal grill to cook, such as hot pot restaurants, charcoal grill restaurants, and so on. Such charcoal grill methods use large quantities of solid fuel. Referring to FIG. 1, in order to prepare in advance a large quantity of fuel to produce a primary self-ignition state, a conventional solid fuel igniter uses a bucket 1, which is partitioned by disposing a dome-shaped grill 11 at a middle portion therein. Air inlets 13 are defined in a lower portion close to a bottom opening 12 of the bucket 1, and a handle 14 is affixed to a side of the bucket 1 to facilitate emptying out solid fuel pieces 10 that have completed self-ignition. A primary fire 2 is prepared under the bucket 1 to enkindle the solid fuel pieces 10.

Flames 20 from the primary fire 2 positioned below the bucket 1 penetrate the dome-shaped grill 11, thereby transmitting heat energy to the lower packed solid fuel pieces 10 within the bucket 1.

However, because the flames 20 rise and concentrate along a center line, thus, fuel pieces 10A positioned close to an inner circumference of the bucket 1 are not only unable to directly receive heat energy from the flames 20, moreover, because of cold air drawn in by the air inlets 13, the fuel pieces 10A will have a lower temperature, which results in a slow speed of heat energy transmission. A catalytic self-ignition phenomenon first occurs in an upward sloping tapered space 21 formed at a center of the stacked solid fuel pieces 10 relative to center of the bucket 1. Moreover, the fuel pieces 10 positioned in the tapered space 21 often burn excessively, whereas the fuel pieces 10A positioned at the inner circumference are unable to reach a uniform self-ignition preparatory state. In addition, the conventional igniter is only able to provide a finite space, which fixes the number of solid fuel pieces 10 that can be packed therein for preheating.

### SUMMARY OF THE INVENTION

The present invention particularly provides an improved structure for a solid fuel igniter, wherein a heat source generating chamber is used to generate a primary fire, and an inverse tapered enclosing body is disposed on top of the generating chamber to provide for loading solid fuel pieces therein. A contracted bottom end of the inverse tapered enclosing body is disposed on a top end opening of the generating chamber, thus, heat energy generated by the generating chamber heats a smaller number of the fuel pieces packed at the bottom contracted opening of the inverse tapered enclosing body.

The solid fuel pieces packed at the bottom contracted opening of the enclosing body are the first to be heated by the primary fire in the generating chamber, and the heat generated after the solid fuel pieces have achieved self-ignition serves as a secondary upward heating source, which subjects the fuel pieces packed in upper portions of the enclosing body to successive and uniform secondary heating.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a side structural view of a conventional igniter.

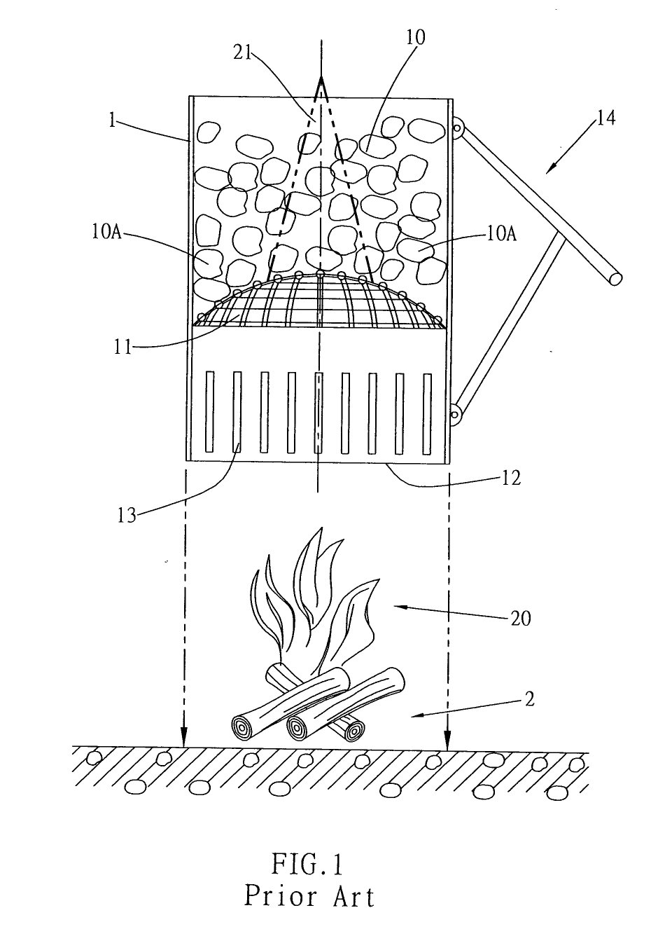

FIG. 2 shows a side structural view of an igniter according to the present invention.

FIG. 3 shows an elevational view of a protective shield configured to surround the igniter according to the present invention.

FIG. 4 shows a side view of the igniter additionally configured with expanding enclosing bodies according to the present invention.

FIG. 5 shows a side view of the igniter being used to cook food according to the present invention.

FIG. 6 shows a side view of the igniter being used to keep warm according to the present invention.

FIG. 7 shows an elevational view of a generating chamber installed with a valve for adjusting airflow according to the present invention.

FIG. 8 shows an elevational view of the generating chamber installed with an auxiliary oil gas burner device according to the present invention.

FIG. 9 shows a side view of a manually operated fan device configured within the generating chamber according to the present invention.

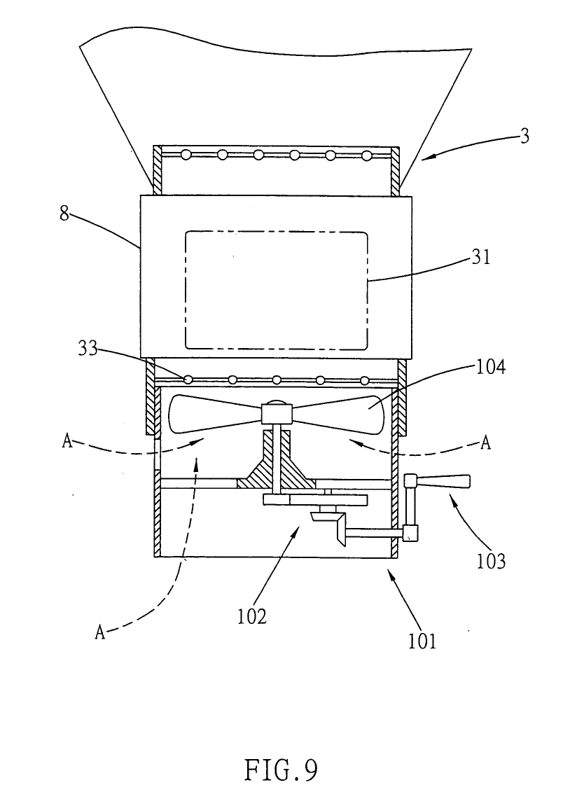

### DETAILED DESCRIPTION OF THE PREFERRED EMBODIMENTS

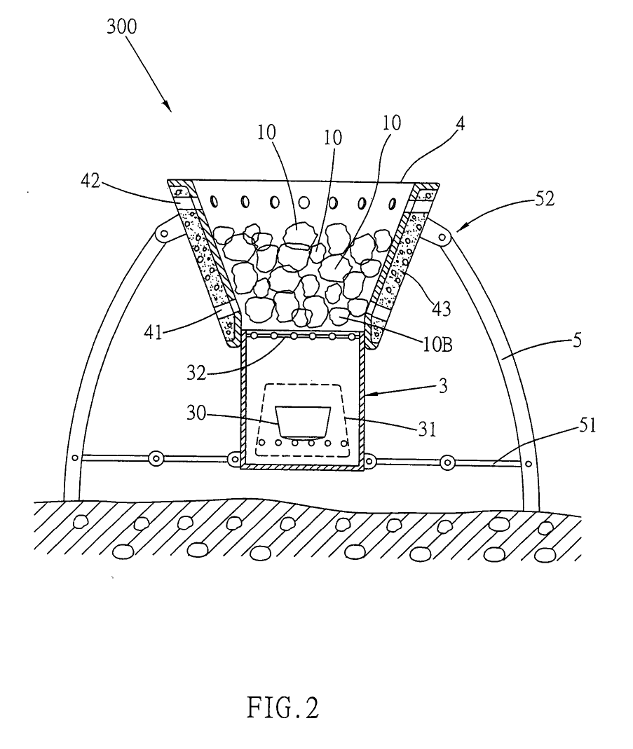

Referring to FIG. 2, which shows an embodiment of an igniter 300 of the present invention, comprising a primary fire generating chamber 3, on top of which is disposed an enclosing body 4 having a top end of any cross sectional shape and a lower end of narrower cross section, for instance, an inverse tapered enclosing body 4. A grill 32 for holding solid fuel pieces 10 is disposed at a top end opening of the generating chamber 3. A feed hole 31 is defined in a side of the generating chamber 3, which provides for placing and removing tinder 30.

In addition to a tapered shape, the enclosing body 4 can further assume a hemispherical shape that embraces a curved inner oblique line to form a cone-shaped enclosing body. In order to make the description simple, the following details only disclose the tapered enclosing body 4.

A plurality of assisting air inlets 41 and air vents 42 are defined in a bottom and a top periphery portion of the Inverse tapered enclosing body 4 respectively.

Frame legs 5 are joined to a periphery of the igniter 300 by means of connecting brackets 52, and braces 51 joined to the frame legs 5 provide outward bracing support.

The grill 32 disposed on the generating chamber 3 supports the loaded solid fuel pieces 10, and heat energy generated by burning the tinder 30 in the generating chamber 3 is transmitted upwards towards the top end opening of the generating chamber 3.

The upwardly expanding design of the inverse tapered enclosing body 4 enables the fuel pieces 10 to gradually increase in number as they are stacked from a lowest layer to a highest layer within the enclosing body 4.

According to the basic concept of the present invention, the heat energy generated within the primary fire generating chamber 3 is first transmitted upwards towards a first layer of fuel pieces 10B loaded at a bottom end opening of the inverse tapered enclosing body 4, which are thus subjected to a heating effect, thereby causing the first layer of fuel pieces 10B to reach a self-ignition state in advance of the other upper layers. The relatively large heat energy generated by the relatively smaller number of fuel pieces 10B in the first layer is radially transmitted upwards, thereby igniting each layer of the fuel pieces 10 as the radiating heat progressively passes therethrough.

Regardless of the method used to stack the fuel pieces 10, the lower fuel pieces 10 closest to a fire source of the generating chamber 3 are inevitably the first to reach a self-ignition state. In addition, prior to reaching ignition point, because the fire pieces 10 also have a heat blocking effect, thus, the lower layer fuel pieces 10B stacked closest to the fire source reach a self-ignition state in advance of the upper layers of fuel pieces 10.

The first layer of fire pieces 10B serves as a fire source for secondary transformation according to the embodiment of the present invention. The primary fire generated in the generating chamber 3 first heats the closest first layer of fire pieces 10B, which undergo self-ignition, thereby generating high secondary heat energy that propagates thermal waves. The next upper layer of fire pieces 10 then undergo secondary heating by the thermal waves, thereby enabling the upper fuel pieces 10 to achieve self-ignition.

Timing for the initial stage of self-ignition to occur is when a majority of the fire pieces 10 have red-hot ignition spots. The lower layer fire pieces 10B will naturally form relatively larger ignition spots, and is the preferred time to achieve overall synchronous self-ignition, which enables obtaining complete heat energy. The timing for self-ignition can be brought forward or delayed according to user requirements.

Furthermore, a heat insulating layer 43 can be additionally disposed around an exterior of the inverse tapered enclosing body 4, thereby providing a heat retaining function and a blocking heat from transmitting outwards.

Referring to FIG. 2A, in order to avoid the danger of being burnt by exterior heat from the igniter 300, the present invention is further configured with a heat blocking and isolating protective shield 50, which stands upright and surrounds the igniter 300. The protective shield 50 is basically fabricated from a sheet body, and through holes 503 can be punched in a breadth of the sheet body to achieve an airflow circulation effect, reduce material weight or economize on material. The protective shield 50 is formed to assume a ring shape and joined to the igniter 300 with connecting members 501, 502. Any material having a heat blocking effect can be adopted as material for the protective shield 50. Furthermore, the protective shield 50 can be also fabricated by weaving of strip-form material or wire-form material.

If position of a bottom end opening 500 of the protective shield 50 is lower than that of the base of the primary fire generating chamber 3, then the bottom end opening 500 functions as a frame leg, thereby causing the primary fire generating chamber 3 to suspend, and preventing the generating chamber 3 from coming in contact with the ground.

Furthermore, a feed hole 504 is defined in the protective shield 50 at a position that enables fuel to be fed into the primary fire generating chamber 3.

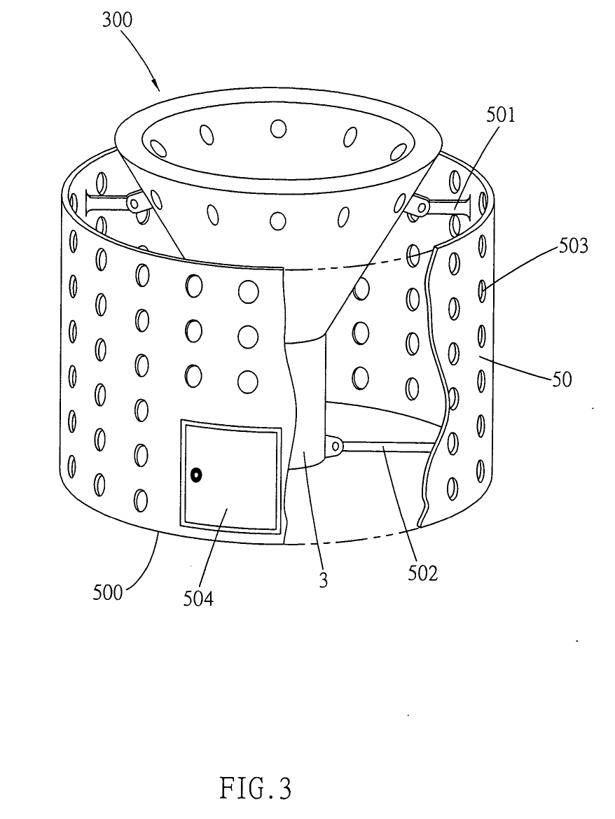

Referring to FIG. 3, which shows a stacking method used to expand ignition effectiveness of the igniter 300 of the present invention, wherein a first expanding enclosing body 40 or a second expanding enclosing member 400 is stacked atop a top expanded opening 45 of the enclosing body 4. Expanding form of the first expanding enclosing body 40 and the second expanding enclosing body 400 have the same tapered gradient as the enclosing body 4 of the igniter 300. The upwardly expanding stacked enclosing bodies 40, 400 are used to contain an additional quantity of the fire pieces 10 ready for ignition. Furthermore, any hardware component that enables fastening together or mutually inserting and assembly of the stacked enclosing bodies 40, 400 can be affixed between the mutually stacked enclosing bodies 40, 400.

The heat insulating layer 43 can be similarly disposed around a periphery of the first or the second expanding enclosing body 40, 400, and auxiliary handles 44 affixed to each of the expanding enclosing bodies 40, 400 facilitate stacking and unstacking of the expanding enclosing bodies 40, 400.

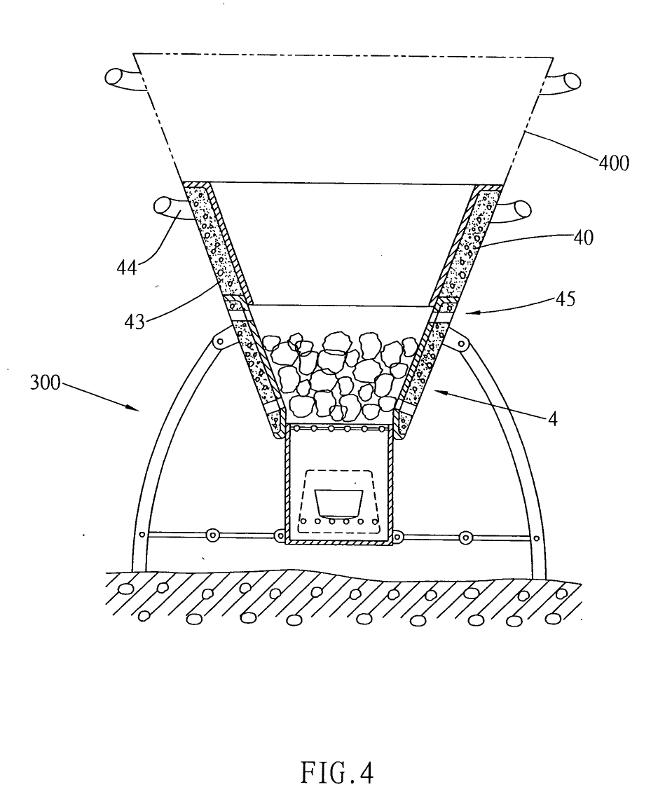

Referring to FIG. 4, which shows the igniter 300 of the present invention, wherein the top expanded opening 45 of the inverse tapered enclosing body 4 is further strengthened with a mechanical structure, thereby enabling a pot 6 to be directly disposed on the igniter 300. A lower exterior of the pot 6 sits on an inner edging of the expanded opening 45, and waste heat produced after burning the solid fuel pieces 10 is outwardly discharged through the air vents 42. Mechanical reinforcement of the expanded opening 45 thus provides for disposing the pot 6 thereon and cooking food, thereby realizing multifunctionality as a stove. Disposition relationship between the pot 6 and the expanded opening 45 can adopt any butt form mutual fitting or any hardware fastening component to assist in fixing placement of the pot 6 on the expanded opening 45.

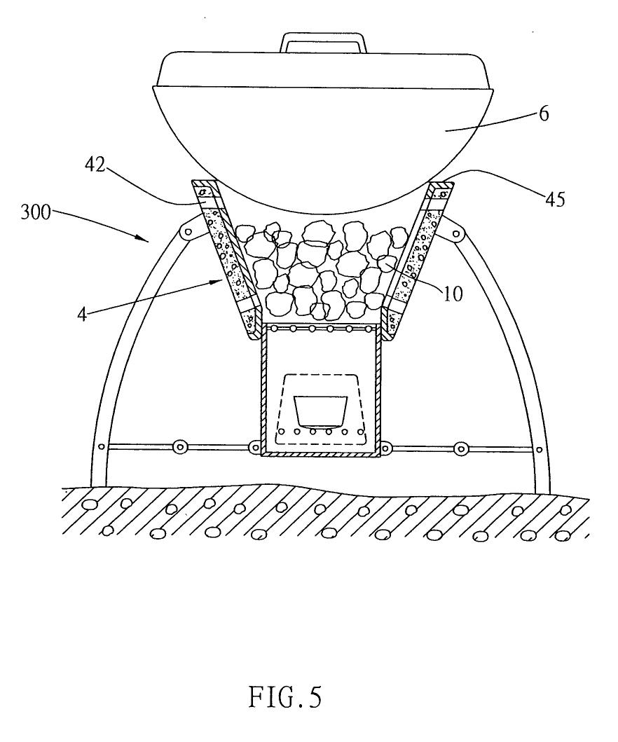

Referring to FIG. 5, because the igniter 300 of the present invention is generally used outdoors, if the outdoor temperature is relatively cold, a protruding cover-form, grid-like far-infrared producing converter can be disposed atop the expanded opening 45 of the enclosing body 4. A bottom end opening 70 of the cover-form far-infrared converter 7 is joined to the top expanded opening 45 of the enclosing body 4, and a plurality of air holes 71 are defined in a surface of the far-infrared producing converter 7. The heat generated after igniting the solid fuel 10 is first transmitted upward towards the far-infrared producing converter 7, wherefrom radiation of far-infrared wavelength is emitted, which can be used to keep warm.

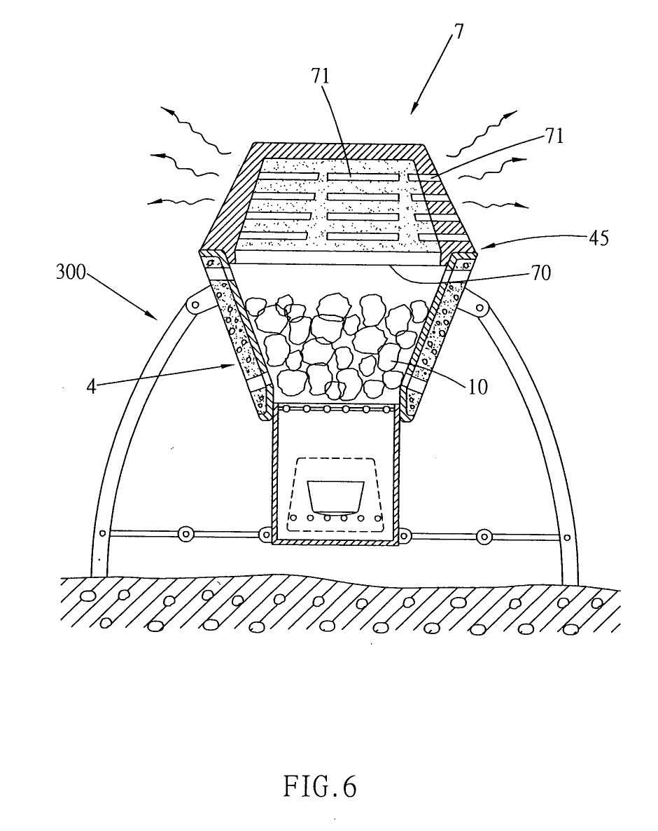

Referring to FIG. 6, the feed hole 31 defined in the primary fire generating chamber 3 provides for feeding the tinder 30, and area size of the feed hole 31 is sufficient for a hand to pass through, whereas an airflow passage is a through hole of larger area, which enables a large amount of air to flow from the generating chamber 3 through the grill 32 and up towards the inverse tapered enclosing body 4. Slowing of burning rate is controlled by reducing supply of oxygen, which is realized by means of an adjusting valve that enables adjusting size of the airflow passage through relative positioning of the feed hole 31. The adjusting valve can be a valve of any form, and an embodiment of the present invention discloses a valve 8 that envelops a breadth of the feed hole 31, and, a valve opening 82 of similar shape is defined in the valve 8 to correspond to the feed hole 31.

Furthermore, the valve 8 is rotated with a toggle arm 81 to open and close the valve opening 82, thereby adjusting relative area size of the feed hole 31, and extreme limits present a completely closed state or a completely open state. Hence, altering the amount of air entering the generating chamber 3 by using the toggle arm 81 to adjust the valve 8 enables regulating burning rate of the solid fuel 10.

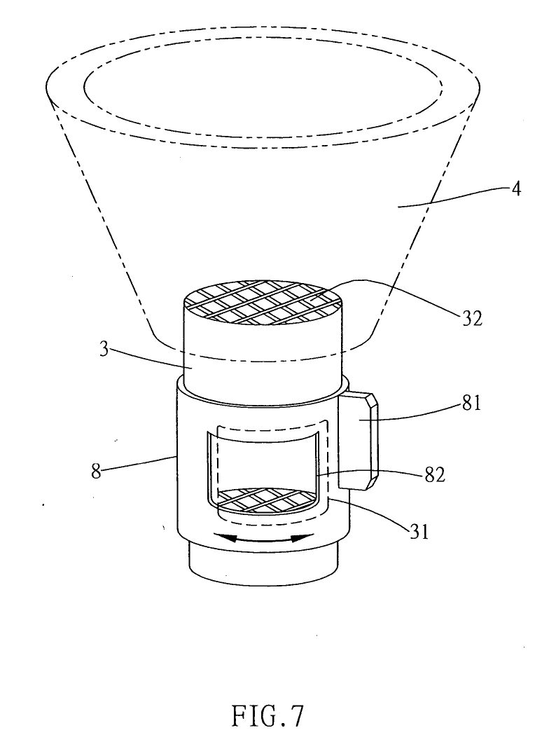

Referring to FIG. 7, apart from using tinder to kindle the primary fire within the generating chamber 3, the present invention can further adopt an oil gas burner as a heat source, wherein a burner head 91 is disposed within the generating chamber 3. Oil gas passes through a pipe line 92, and a valve 93 controls the amount entering the generating chamber 3; whereafter flames are produced by burning the oil gas at the burner head 91.

Furthermore, the feed hole 31 in conjunction with functionality of the aforementioned valve 8 effectuates an open and close adjusting operation.

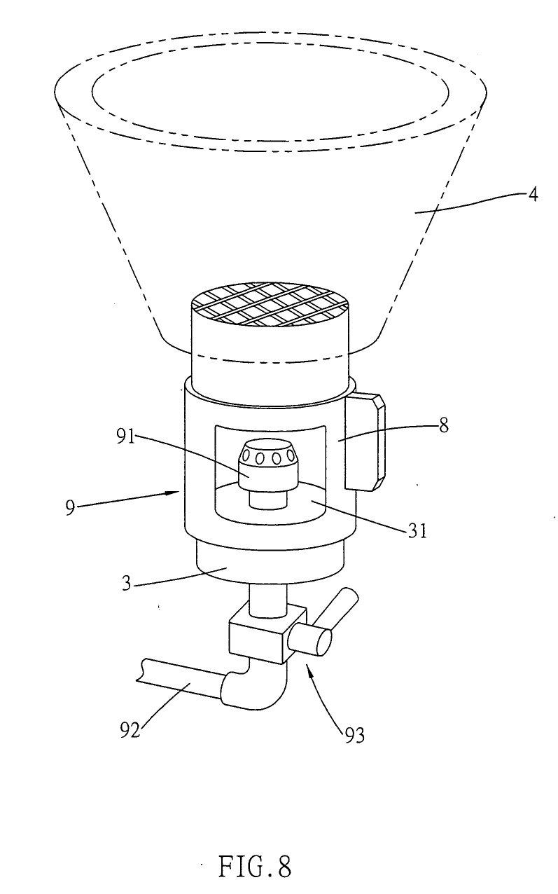

Referring to FIG. 8, which shows the present invention with a manually operated fan device 101 further disposed at a lower end of the generating chamber 3. The fan device 101 is driven by a shaft configuration through an amplifying gear set 102, and the hand of a user operates a jointed arm 103 to actuate and amplify rotating speed of coaxially-arranged fan blades 104, creating a fan effect that blows air A into the generating chamber 3.

When the fan device 101 is used as a stove in an embodiment of the present invention, then the ring-shaped valve 8 can be closed to seal the feed hole 31.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A solid fuel igniter that provides for initial heating of solid fuel pieces to expedite reaching a self-ignition state, comprising a primary fire generating chamber, on top of which is disposed an inverse tapered enclosing body, and a flat grill disposed between the primary fire generating chamber and the inverse tapered enclosing body.

2. The solid fuel igniter as described in claim 1 wherein air vents and assisting air inlets are defined in a top and a bottom periphery portion of the Inverse tapered enclosing body respectively.

3. The solid fuel igniter as described in claim 1, wherein at least one expanding enclosing body is additionally disposed atop a top expanded opening of the inverse tapered enclosing body.

4. The solid fuel igniter as described in claim 1, wherein a heat insulating layer is further disposed around peripheries of the enclosing body and the expanding enclosing bodies.

5. The solid fuel igniter as described in claim 1, wherein a periphery of the igniter is further configured with a protective shield, which stands upright and surrounds the igniter, and connecting members are affixed to the protective shield for joining to the igniter.

6. The solid fuel igniter as described in claim 1, wherein a far-infrared producing converter is disposed on the expanded opening of the enclosing body.

7. The solid fuel igniter as described in claim 1, wherein an oil burner or a gas burner is further configured within the generating chamber.

8. The solid fuel igniter as described in claim 1, wherein a manually operated fan device is further configured on a lower end of the generating chamber.

9. The solid fuel igniter as described in claim 1, wherein frame legs are respectively radially joined to a periphery of the igniter.

10. The solid fuel igniter as described in claim 9, wherein the frame legs are assembled by means of a pivotly connecting method.

11. The solid fuel igniter as described in claim 1, wherein a feed hole is defined in the generating chamber.

12. The solid fuel igniter as described in claim 11, wherein the feed hole is subject to relative opening and closing by a valve opening defined in a valve movably disposed on a periphery of the generating chamber, thereby achieving control of the amount of airflow.
